(19) United States
(12) Patent Application Publication
(10) Pub. No.: US 2016/0363541 A1
(43) Pub. Date: Dec. 15, 2016

(54) INSPECTION APPARATUS AND INSPECTION METHOD

(71) Applicant: Kabushiki Kaisha Toshiba, Minato-ku (JP)

(72) Inventor: Kiminori YOSHINO, Yokkaichi (JP)

(73) Assignee: Kabushiki Kaisha Toshiba, Minato-ku (JP)

(21) Appl. No.: 15/003,914

(22) Filed: Jan. 22, 2016

Related U.S. Application Data
(60) Provisional application No. 62/175,740, filed on Jun. 15, 2015.

(51) Int. Cl. G01N 21/95; G06T 7/00; G01N 21/21; G06K 9/62

(52) U.S. Cl. CPC G01N 21/9501; G06K 9/627; G06K 9/6215; G06T 7/0008; G06T 7/001; G01N 21/21; G06T 2207/10056; G06T 2207/30148; G01N 2201/0683; G01N 2201/12

(57) ABSTRACT

In accordance with an embodiment, an inspection apparatus includes an irradiating section, a detecting section and a control section. The irradiating section is configured to irradiate a sample with light. The detecting section is configured to detect the light reflected by the sample. The control section is configured to classify defects of the sample on the basis of a difference between a first signal outputted from the detecting section by irradiating the sample with the light under a first optical condition and a second signal outputted from the detecting section by irradiating the sample with the light under a second optical condition different from the first optical condition.

### CROSS REFERENCE TO RELATED APPLICATIONS

This application is based upon and claims the benefit of U.S. provisional Application No. 62/175,740, filed on Jun. 15, 2015, the entire contents of which are incorporated herein by reference.

### FIELD

Embodiments described herein relate generally to an inspection apparatus and an inspection method.

### BACKGROUND

In manufacturing a semiconductor device improvement of a yield is achieved through detection of defects by using an appearance defect inspection apparatus or the like, finding out origins or causes of the defects and improving concerned processes.

The detected defects are classified into categories in accordance with characteristics, e.g., a size, a shape, a gray level, a white/black level and the like of an obtained sample image.

Heretofore, the classification of the defects has be carried out by preparing a defect-free image as a reference image, and then specifying the size, the gray level and the like of each defect from a difference between an image obtained from an inspection object and the reference image.

In recent years, to meet needs for higher densification, there has been developed a device such as a three-dimensional memory cell in which layers of the same structure are repeatedly laminated.

However, along with the high densification, it has become difficult to accurately classify the defects inclusive of defects present in the image.

### BRIEF DESCRIPTION OF THE DRAWINGS

In the accompanying drawings:

FIG. 1 is one example of a block diagram showing a schematic constitution of an inspection apparatus according to one embodiment;

FIG. 2A to FIG. 2C are examples of a view to explain an inspection in a state where the surface of a sample is focused;

FIG. 3A to FIG. 3C are examples of a view to explain an inspection in a state where an inner portion of the sample is focused;

FIG. 4A to FIG. 4C are views showing examples of a difference image;

FIG. 5 is a diagram showing one example of a characteristic amount space diagram obtained in a focus mode;

FIG. 6A to FIG. 6D are schematic views showing four types of defect examples in wires of a line and space pattern;

FIG. 7A to FIG. 7D are views showing examples of an image obtained by polarization in a direction orthogonal to a longitudinal direction of the wires shown in FIG. 6A to FIG. 6D;

FIG. 8A to FIG. 8D are views showing examples of an image obtained by polarization in a direction parallel to the longitudinal direction of the wires shown in FIG. 6A to FIG. 6D; and

FIG. 9 is one example of a flowchart showing a schematic procedure of an inspection method according to one embodiment.

### DETAILED DESCRIPTION

In accordance with an embodiment, an inspection apparatus includes an irradiating section, a detecting section and a control section. The irradiating section is configured to irradiate a sample with light. The detecting section is configured to detect the light reflected by the sample. The control section is configured to classify defects of the sample on the basis of a difference between a first signal outputted from the detecting section by irradiating the sample with the light under a first optical condition and a second signal outputted from the detecting section by irradiating the sample with the light under a second optical condition different from the first optical condition.

Embodiments will now be explained with reference to the accompanying drawings. Like components are provided with like reference signs throughout the drawings and repeated descriptions thereof are appropriately omitted. It is to be noted that the accompanying drawings illustrate the invention and assist in the understanding of the illustration and that the shapes, dimensions, and ratios and so on in each of the drawings may be different in some parts from those in an actual apparatus.

(A) Inspection Apparatus

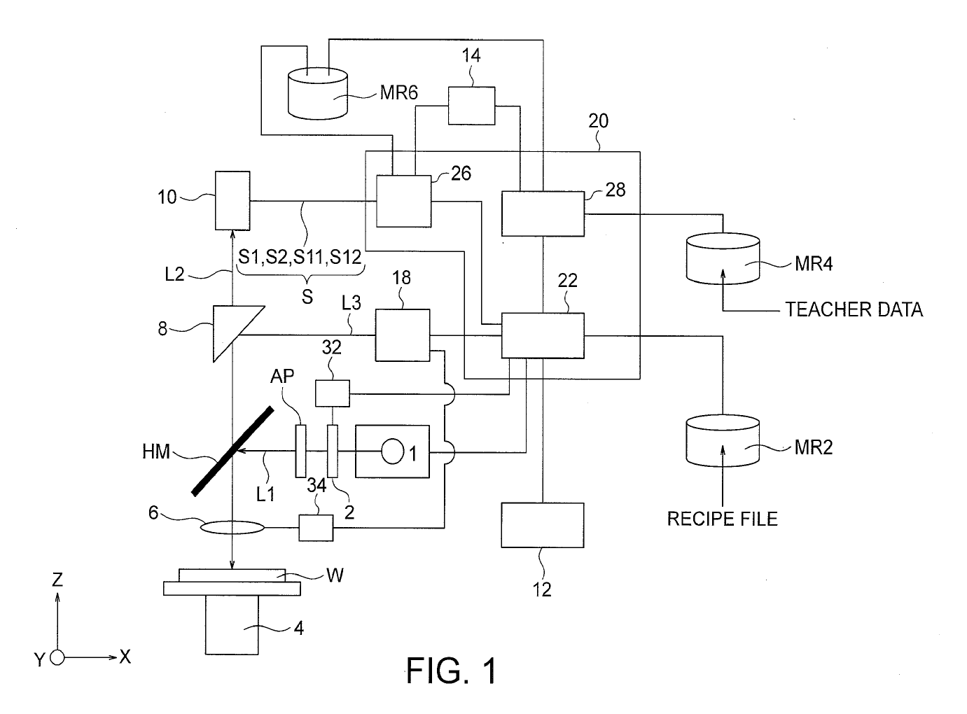

An inspection apparatus according to one embodiment will be described with reference to FIG. 1 to FIG. 8. Hereinafter, a case where the apparatus is applied to a bright field inspection apparatus will be described as one example, but the present invention is not limited to this example, and needless to say, the present invention is also applicable to a dark field inspection apparatus which evaluates color gradations of defect and background images are evaluated with signal strengths.

(1) Constitution

FIG. 1 is one example of a block diagram showing a schematic constitution of an inspection apparatus according to the present embodiment. The inspection apparatus shown in FIG. 1 includes a light source 1, a polarizing filter 2, a polarizing filter moving section 32, an aperture AP, a half mirror HM, an objective lens 6, a lens position adjusting section 34, a stage 4, a beam splitter 8 for AF, an AF processing section 18, a detector 10, a display device 14, an input device 12, and a control computer 20.

The control computer 20 corresponds to, for example, a control section in the present embodiment, and includes a central control section 22, an image processing section 26, and a defect classifying section 28.

The central control section 22 is connected to the input device 12, the light source 1, the polarizing filter moving section 32, the AF processing section 18, the image processing section 26, and the defect classifying section 28.

In a memory MR2, a recipe file is stored in which a series of programs to perform after-mentioned defect classification are described. At the start of inspection, the central control section 22 reads the recipe file from the memory MR2 and generates various instructing signals to send the signals to connected constitutional elements, thereby automatically performing appearance inspection and the defect classification.

The input device 12 inputs various set values and parameter data required for the appearance inspection and the defect classification into the central control section 22 in accordance with an operator's operation.

The stage 4 holds a sample which is an inspection object. In the present embodiment, a wafer W in which a pattern is formed will be described as one example of the sample.

The light source 1 follows the instructing signal from the central control section 22 to generate light L1, thereby emitting the light. The light L1 may be lamp light or laser light, or may be single wavelength light or broadband light.

The polarizing filter moving section 32 follows the instructing signal from the central control section 22 to move the polarizing filter 2 by a drive mechanism such as an unshown actuator. More specifically, the polarizing filter moving section 32 disposes the polarizing filter 2 on its optical path so that the light L1 from the light source 1 passes the filter when an inspection mode switches to an after-mentioned polarization mode, and rotates the polarizing filter 2 on the basis of an intersecting point with the optical path in a plane parallel to a plane (a Y-Z plane in the example shown in FIG. 1) orthogonal to the optical path of the light L1 when a polarizing direction is changed.

The objective lens 6 condenses the light L1 which passes the aperture AP and/or the polarizing filter 2 and is reflected by the half mirror HM to drop, and irradiates the wafer W with the light at a desirable focal position.

Reflected light L2 from the wafer W on which the light L1 has dropped passes the objective lens 6 and the half mirror HM, a part of the light passes the beam splitter 8 for the AF to enter the detector 10, and a part of the light is reflected by the beam splitter 8 for the AF to enter the AF processing section 18. In the present embodiment, the light source 1, the aperture AP, the half mirror HM and the objective lens 6 correspond to, for example, an irradiating section.

The AF processing section 18 follows the instructing signal from the central control section 22 to detect light L3 entering from the beam splitter 8 for the AF, thereby calculating the focal position of the objective lens 6, and generates a control signal to send the signal to the lens position adjusting section 34. The lens position adjusting section 34 follows the control signal from the AF processing section 18 to move the objective lens 6 so that a targeted focal position can be realized by an unshown moving mechanism.

The detector 10 detects the light L2 which has passed the objective lens 6, the half mirror HM and the beam splitter 8 for the AF to enter the detector, and outputs a signal S. The signal S includes signals S1 and S2 obtained in a focus mode and signals S11 and S12 obtained in the polarization mode as described later.

The image processing section 26 generates an optical microscope image including the pattern formed on the surface of the wafer W on the basis of the signal S sent from the detector 10, stores the image in a memory MR6, and displays the image in the display device 14. In consequence, it is possible to confirm presence/absence of defects in the wafer W.

The defect classifying section 28 extracts, from the memory MR6, the optical microscope image generated from the signal S obtained under a different optical condition, calculates a difference between the images, and further calculates a characteristic amount as to the obtained difference when necessary. In the present embodiment, the difference between the optical microscope images corresponds to, for example, a difference between a first signal and a second signal.

In a memory MR4, there is stored a rule (hereinafter referred to as “teacher data”) for classification beforehand obtained for each type of defect in each inspection mode.

The defect classifying section 28 further extracts the teacher data from the memory MR4, collates the difference or the characteristic amount of the difference with the teacher data to classify the defects of the pattern on the wafer W, displays the classified defects in the display device 14, and then stores them in the memory MR4.

(2) Operation

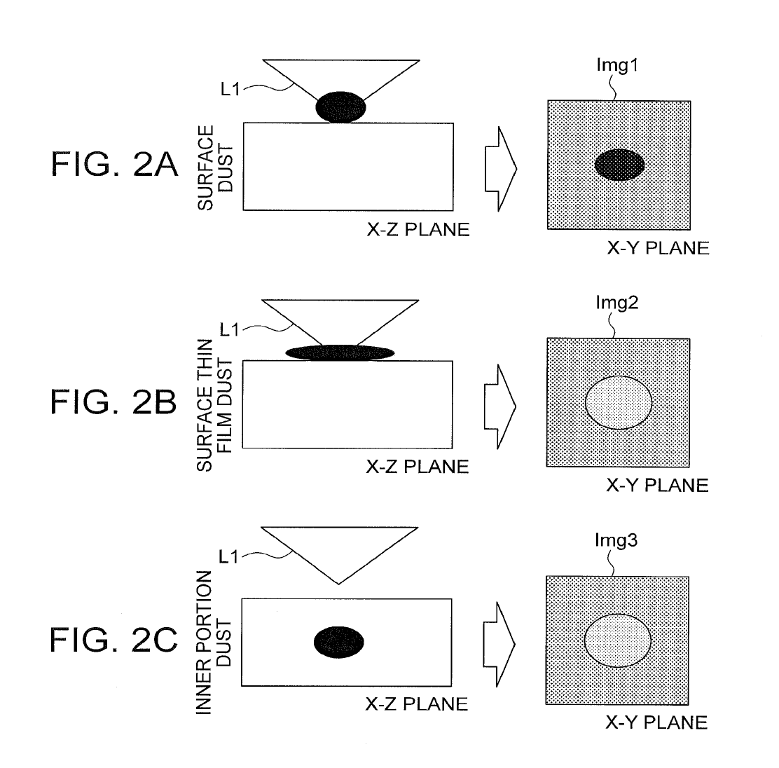

The inspection apparatus shown in FIG. 1 is operable in two modes, i.e., the focus mode in which a focus is changed to improve accuracy of automatic defect classification and the polarization mode in which the polarizing direction is changed to improve the accuracy of the automatic defect classification. Hereinafter, operations in the respective modes will be described with reference to FIG. 2 to FIG. 8.

(a) Focus Mode

First, the automatic defect classification in the focus mode will be described.

The operator selects the focus mode via the input device 12 and further inputs necessary parameter data. The parameter data includes information of the focal position when inner portion dust is focused.

When the focus mode is selected, the AF processing section 18 and the lens position adjusting section 34 adjust a position of the objective lens 6 to focus the surface of the wafer W. In addition, when the focus mode is selected, the polarizing filter moving section 32 adjusts a position of the polarizing filter 2 so that the polarizing filter 2 is separated from the optical path of the light L1.

Next, the light L1 is emitted from the light source 1, passes the half mirror HM and the objective lens 6, and drops at a just-focus position on the surface of the wafer W. The reflected light L2 from the wafer W passes the half mirror HM and the beam splitter 8 for the AF to enter the detector 10, and is detected, and the signal S1 is sent from the detector 10 to the image processing section 26. The signal S1 corresponds to, for example, the first signal in the focus mode of the present embodiment.

The image processing section 26 generates the optical microscope image on the surface of the wafer W from the signal S1, stores the image in the memory MR6, and displays the image in the display device 14. In the focus mode of the present embodiment, the focus on the surface of the wafer W corresponds to, for example, a first optical condition.

Three types of defects will be described. FIG. 2A to FIG. 2C show examples of the optical microscope image of the wafer W including these defects.

FIG. 2A shows a cross-sectional view along a cutting line parallel to an X-Z plane and an example of the entering light (on the left side of a paper surface) and an obtained optical microscope image Img1 (an X-Y plane view on the right side of the paper surface) concerning an example where dust adheres to the surface of the sample (hereinafter referred to as “the surface dust”).

FIG. 2B shows a cross-sectional view along the cutting line parallel to the X-Z plane and an example of the entering light L1 (on the left side of the paper surface) and an obtained optical microscope image Img2 (an X-Y plane view on the right side of the paper surface) concerning an example where a thin film as the dust adheres to the surface of the sample (hereinafter referred to as “the surface thin film dust”).

FIG. 2C shows a cross-sectional view along the cutting line parallel to the X-Z plane and an example of the entering light L1 (on the left side of the paper surface), and an obtained optical microscope image Img3 (an X-Y plane view on the right side of the paper surface) concerning an example where the dust remains to be buried in the sample (hereinafter referred to as “the inner portion dust”).

Next, the AF processing section 18 and the lens position adjusting section 34 adjusts the position of the objective lens 6 to focus the inner portion dust of the wafer W. Afterward, the light L1 is emitted from the light source 1, the reflected light L2 is detected by the detector 10, and the optical microscope image is generated from the signal S2 from the detector 10 by the image processing section 26, stored in the memory MR6 and also displayed in the display device 14. In the focus mode of the present embodiment, the focus on the inner portion dust of the wafer W corresponds to, for example, a second optical condition and the signal S2 corresponds to, for example, the second signal.

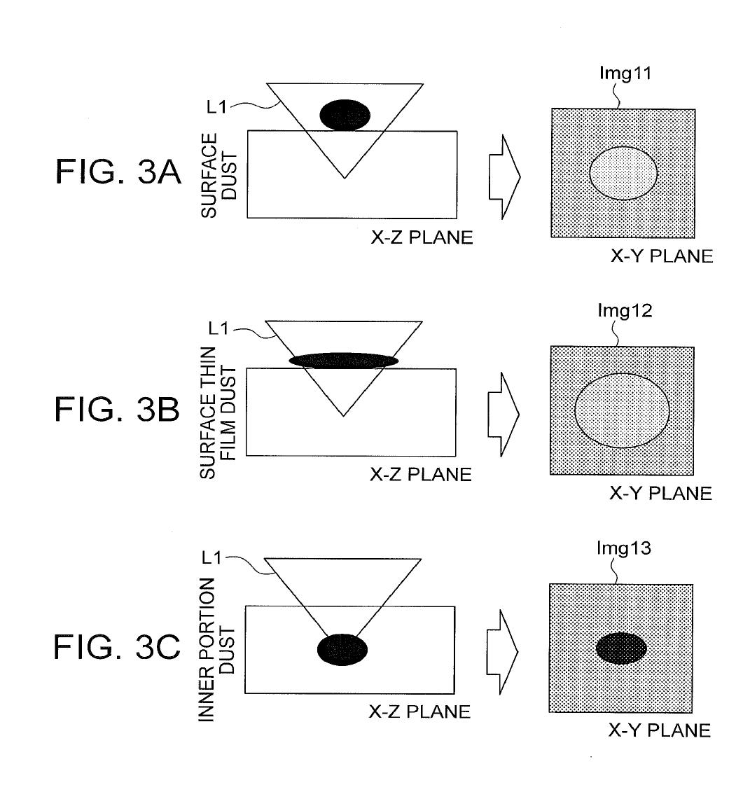

FIG. 3A shows an example of the entering light L1 focused on the inner portion dust (on the left side of the paper surface) and an obtained optical microscope image Imgll (the X-Y plane view on the right side of the paper surface) concerning the surface dust.

FIG. 3B shows an example of the entering light L1 focused on the inner portion dust (on the left side of the paper surface) and an obtained optical microscope image Img12 (the X-Y plane view on the right side of the paper surface) concerning the surface thin film dust.

FIG. 3C shows an example of the entering light L1 focused on the inner portion dust (on the left side of the paper surface) and an obtained optical microscope image Img13 (the X-Y plane view on the right side of the paper surface) concerning the inner portion dust.

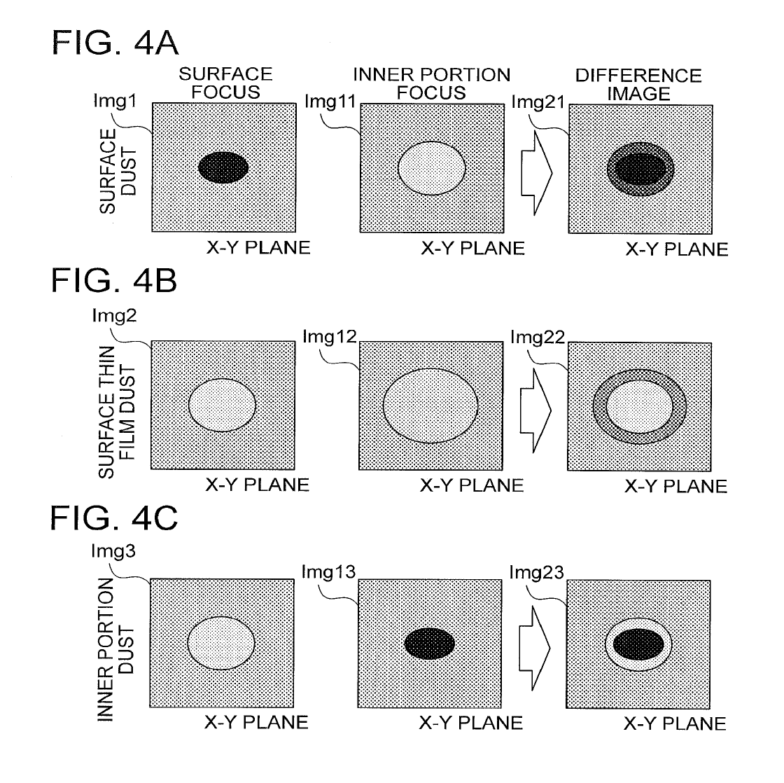

Subsequently, each difference image between one of the optical microscope images Img1 to Img3 obtained by the surface focus and one of the optical microscope images Img11 to 13 obtained by the inner portion focus is generated by the defect classifying section 28. FIG. 4A to FIG. 4C show examples of the generated difference images together with the corresponding optical microscope images.

FIG. 4A shows a difference image Img21 between the optical microscope image Img1 obtained by the surface focus and the optical microscope image Img11 obtained by the inner portion focus together with the respective optical microscope images Img1 and Img11 concerning the surface dust.

FIG. 4B shows a difference image Img22 between the optical microscope image Img2 obtained by the surface focus and the optical microscope image Img12 obtained by the inner focus together with the respective optical microscope images Img2 and Img12 concerning the surface thin film dust.

FIG. 4C shows a difference image Inng23 between the optical microscope image Img3 obtained by the surface focus and the optical microscope image Img13 obtained by the inner focus together with the respective optical microscope images Img3 and Img13 concerning the dust in the film.

Next, the characteristic amounts of the obtained difference images Img21 to Img23 are calculated by the defect classifying section 28. Here, the characteristic amount is an amount which characterizes a shape or a pixel value (a gray value) of a portion corresponding to the defect in the difference image, e.g., a circle or an ellipse, or white or black. In the present embodiment, a circularity of the shape of the portion corresponding to the defect in the difference image and a length of the portion in an X-direction or a Y-direction are selected as the characteristic amounts. When the characteristic amount is calculated, all digitized data are used on the basis of the pixel values of the respective images.

When the characteristic amount is calculated, the defects in the respective difference images are next classified by the defect classifying section 28 with reference to the teacher data stored in the memory MR4.

As algorithms for the classification, there are various methods, e.g., a method in which a decision tree or a support vector is used, correlation rule learning, and neural network. In the present embodiment, any one of the algorithms is applicable.

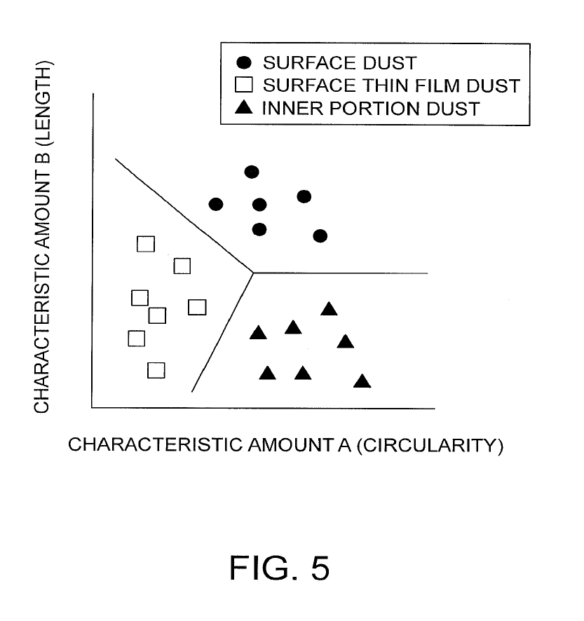

FIG. 5 shows one example of a characteristic amount space diagram in which the defects are classified. As shown in FIG. 5, it is seen that the defects can be classified into three defect types, i.e., the surface dust, the surface thin film dust and the inner portion dust.

Thus, the inspection apparatus of the present embodiment includes the defect classifying section 28 which generates the difference image between the optical microscope images obtained by the different focuses, calculates the characteristic amount of the difference image, and classifies the defects with reference to the teacher data, and hence, it is possible to accurately perform the automatic defect classification not only of surface defects but also of defects present in the inner portion.

(b) Polarization Mode

Next, the automatic defect classification in the polarization mode will be described.

The operator selects the polarization mode via the input device 12. In this case, a direction of polarization to be started is instructed together.

To facilitate understanding, four types of defects generated in wires of a line and space pattern will be described.

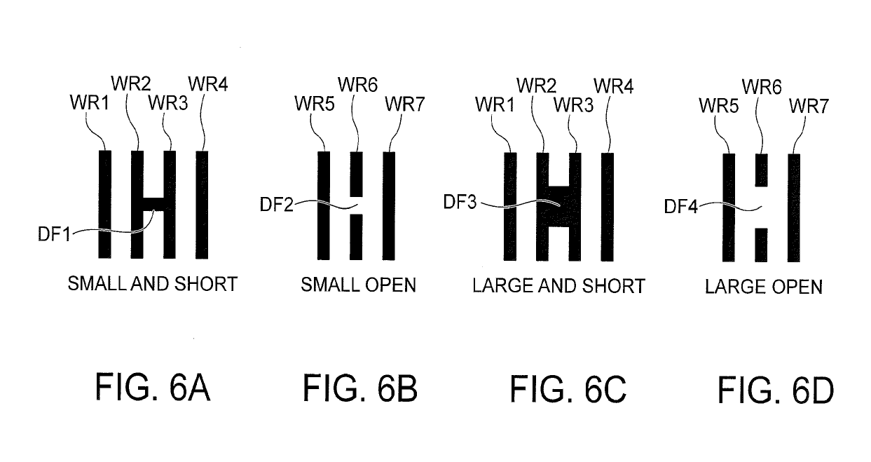

FIG. 6A to FIG. 6D are schematic views showing examples of the wires in which the defects are generated.

FIG. 6A shows one example where there is generated a comparatively small and short defect DF1 which short-circuits wires WR2 and WR3 among four wires WR1 to WR4. FIG. 6B shows one example where a comparatively small open defect DF2 is generated in a central wire WR6 among three wires WR5 to WR7.

FIG. 6C shows one example where there is generated a comparatively large and short defect DF3 which short-circuits the wires WR2 and WR3 among the four wires WR1 to WR4. FIG. 6D shows one example where a comparatively large open defect DF4 is generated in the central wire WR6 among the three wires WR5 to WR7.

As to the wires of the line and space pattern, the signals, i.e., the images to be obtained from the detector 10 are different between polarization (hereinafter simply referred to as “orthogonal polarization”) irradiation from a direction orthogonal to a longitudinal direction of the wires and polarization (hereinafter simply referred to as “parallel polarization”) irradiation from a direction parallel to the longitudinal direction. Hereinafter, there will be described an example where the irradiation is first performed with the orthogonal polarization and then the irradiation is performed with the parallel polarization. Needless to say, the order of the polarization irradiations is not limited to this order, but the irradiations may be performed in a reverse order. In the polarization mode of the present embodiment, the orthogonal polarization corresponds to, for example, the first optical condition and the parallel polarization corresponds to, for example, the second optical condition.

When the polarization mode is selected, the polarizing filter 2 is moved via an unshown drive mechanism by the polarizing filter moving section 32, whereby the polarizing filter is disposed on the optical path from the light source 1 to the half mirror HM. In the present embodiment, an angle of the polarizing filter 2 is adjusted in a plane parallel to the Y-Z plane on the basis of an intersection with the optical path so that the irradiation is performed with the orthogonal polarization. Furthermore, the light AF processing section 18 and the lens position adjusting section 34 adjust the position of the objective lens 6 to focus the surface of the wafer W.

Next, the light L1 is emitted from the light source 1, and passes the polarizing filter 2, the aperture AP, the half mirror HM and the objective lens 6 to drop at the just-focus position on the surface of the wafer W. The reflected light L2 from the wafer W passes the half mirror HM and the beam splitter 8 for the AF to enter the detector 10, and is detected. The signal S11 outputted from the detector 10 is sent to the image processing section 26, and the optical microscope image on the surface of the wafer W is generated, stored in the memory MR6, and also displayed in the display device 14. The signal S11 corresponds to, for example, the first signal in the polarization mode of the present embodiment.

In the polarization mode of the present embodiment, when the image is generated in the polarization mode, the image processing section 26 generates an image of 150 gradations in a background of 256 gradations.

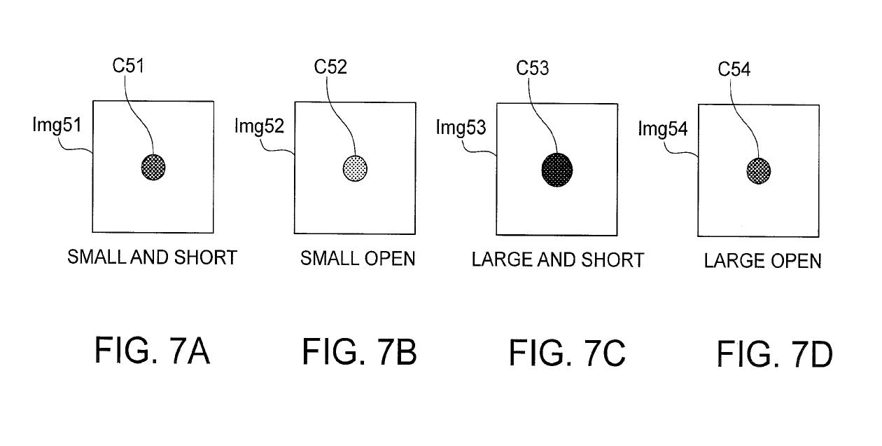

FIG. 7A to FIG. 7D show examples of the images obtained by the orthogonal polarization concerning the wires shown in FIG. 6A to FIG. 6D, respectively. Gradation values of portions C51 to C54 corresponding to the respective defects DF1 to DF4 in images Img51 to Img54 are as follows, respectively.

C51: 120

C52: 140

C53: 100

C54: 120

Here, when gradation differences between the portions C51 to C54 and the background are defined as GDoC51 to GDoc54, respectively, the differences are as follows.

GDoC51: Δ30

GDoC52: Δ10

GDoC53: Δ50

GDoC54: Δ30

These gradation values and gradation differences are calculated by the defect classifying section 28 and stored in the memory MR6.

In general, when the sample is observed by the orthogonal polarization, short defects are easy to be seen and open defects are hard to be seen. Also in the examples of FIG. 7A to FIG. 7D, the gradation difference GDoC51 of the comparatively small and short defect DF1 (see C51) and the gradation difference GDoC54 of the comparatively large open defect DF4 (see C54) are both Δ30, and it is presumed that it is difficult to separate these defects only by the observation in the orthogonal polarization.

When the gradation difference in the orthogonal polarization is calculated, the polarizing filter 2 is moved by the direction polarizing filter moving section 32. Here, the polarizing filter 2 rotates as much as 90° in the plane parallel to the Y-Z plane on the basis of the intersection with the optical path so that the irradiation with the parallel polarization is performed.

Next, the light L1 is emitted from the light source 1, and passes the polarizing filter 2, the aperture AP, the half mirror HM and the objective lens 6 to drop at the just-focus position on the surface of the wafer W. The reflected light L2 from the wafer W passes the objective lens 6, the half mirror HM and the beam splitter 8 for the AF to enter the detector 10, and is detected. The signal S12 outputted from the detector 10 is sent to the image processing section 26, and the optical microscope image of the surface of the wafer W is generated, stored in the memory MR6 and also displayed in the display device 14. In the polarization mode of the present embodiment, the signal S12 corresponds to, for example, the second signal.

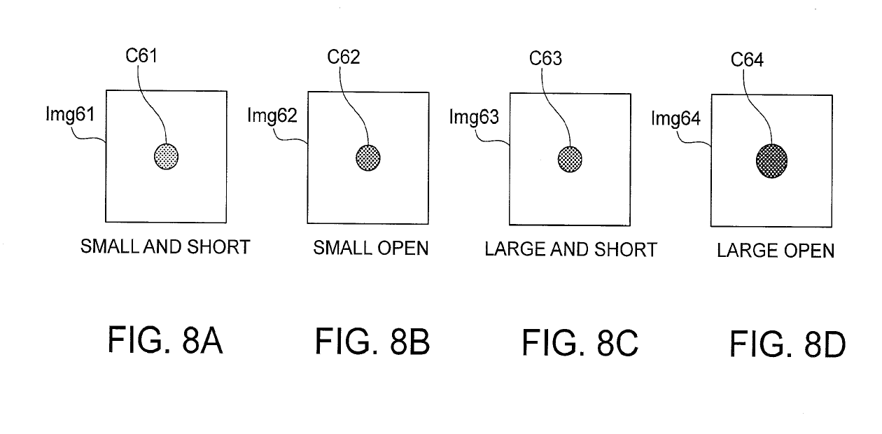

FIG. 8A to FIG. 8D show examples of images obtained by the parallel polarization concerning the wires shown in FIG. 6A to FIG. 6D. Gradation values of portions C61 to C64 corresponding to the respective defects DF1 to DF4 in images Img61 to Img64 are as follows, respectively.

C61: 140

C62: 130

C63: 130

C64: 120

Here, when gradation differences between the portions C61 to C64 and the background are defined as GDpC61 to GDpC64, respectively, the differences are as follows.

GDpC61: Δ10

GDpC62: Δ20

GDpC63: Δ20

GDpC64: Δ30

These gradation values and gradation differences are also calculated by the defect classifying section 28 and stored in the memory MR6.

In general, when the sample is observed by the parallel polarization, the open defects are easy to be seen and the short defects are hard to be seen. Also in the examples of FIG. 8A to FIG. 8D, the gradation difference GDpC62 of the comparatively small open defect DF2 (see C62) and the gradation difference GDpC63 of the comparatively large and short defect DF3 (see C63) are both Δ20, and it is presumed that it is difficult to separate these defects only by the observation in the parallel polarization.

When the gradation differences of the respective optical microscope images and the mutual gradation differences are obtained in each of the orthogonal polarization and the parallel polarization, the defect classifying section 28 extracts data of the gradation differences in the orthogonal polarization and the gradation differences in the parallel polarization from the memory MR6, and calculates differences between the gradation differences in the orthogonal polarization and the gradation differences in the parallel polarization. As a result, the calculation results can be obtained as follows.

GDpC61−GDoC51:Δ10−Δ30=+20

GDpC62−GDoC52:Δ20−Δ10=Δ10

GDpC63−GDoC53:Δ20−Δ50=+30

GDpC64−GDoC54:Δ30−Δ30=0

Finally, the defect classifying section 28 collates the abovementioned calculation results with the teacher data, and judges whether each of regions corresponding to the images Img51 to Img54 or the images Img61 to Img64 belongs to one of the comparatively small open defect, the comparatively large open defect, the comparatively small and short defect and the comparatively large and short defect. Here, the teacher data is difference data beforehand measured between the gradation difference in the orthogonal polarization and the gradation difference in the parallel polarization.

Thus, the inspection apparatus of the present embodiment includes the defect classifying section 28 which further calculates the differences of the gradation differences between the regions corresponding to the defects and the background among the images obtained by the polarizations in the different mutually intersecting directions, and hence, it is possible to perform the automatic defect classification by calculation processing based on the gradation values.

The inspection apparatus of at least one of the abovementioned embodiments includes the defect classifying section 28 which classifies the defects of the wafer W by use of the first signal obtained by irradiating the sample with the light under the first optical condition and the second signal obtained by irradiating the sample with the light under the second optical condition different from the first optical condition, and hence, the defects can accurately be classified.

(B) Inspection Method

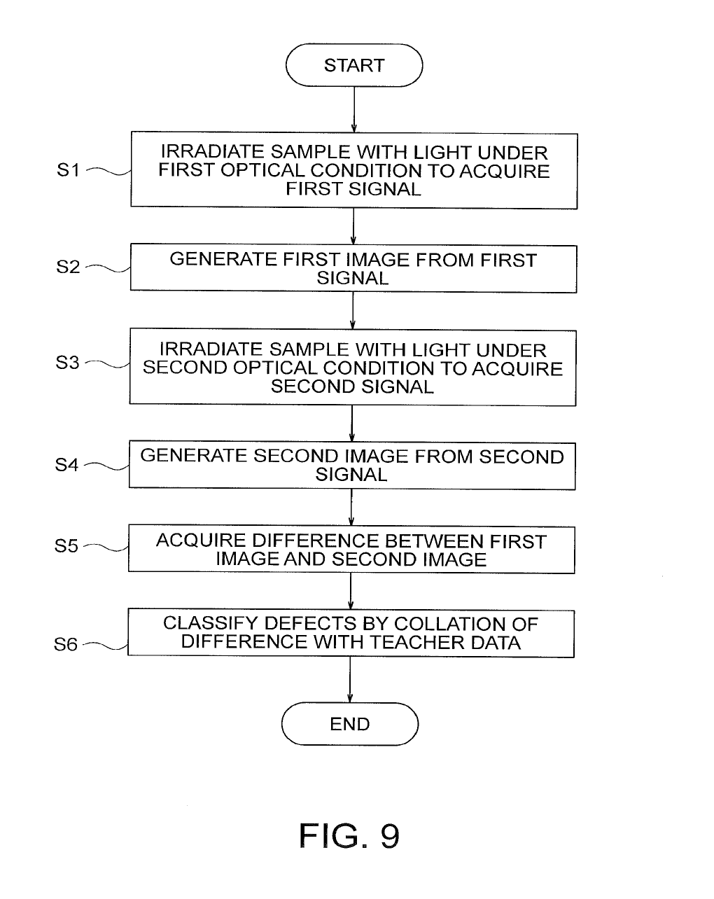

An inspection method according to one embodiment will be described with reference to a flowchart of FIG. 9.

First, the sample is irradiated with the light under the first optical condition, and the light emitted from the sample is detected to acquire the first signal (step S1).

Examples under the first optical condition include the focus on the surface of the sample in the abovementioned focus mode of the inspection apparatus, and the orthogonal polarization in the abovementioned polarization mode. In addition, examples of the first signal include the signal S1 to be outputted from the detector 10 in the abovementioned focus mode, and the signal S11 to be outputted from the detector 10 in the abovementioned polarization mode.

Next, a first image is generated from the obtained first signal (step S2).

Examples of the first image include the images Img1 to Img3 obtained by the focus on the sample surface in the abovementioned focus mode of the inspection apparatus, and the images Img51 to Img53 obtained by the orthogonal polarization in the abovementioned polarization mode of the inspection apparatus.

Subsequently, the sample is irradiated with the light under the second optical condition, and the light emitted from the sample is detected to acquire the second signal (step S3).

Examples under the second optical condition include the focus on the inner portion dust of the sample in the abovementioned focus mode of the inspection apparatus, and the parallel polarization in the abovementioned polarization mode of the inspection apparatus.

Next, a second image is generated from the obtained second signal (step S4).

Examples of the second image include the images Img11 to Img13 obtained by the focus on the inner portion dust of the sample in the abovementioned focus mode of the inspection apparatus, and the images Img61 to Img63 obtained by the parallel polarization in the abovementioned polarization mode of the inspection apparatus.

Subsequently, a difference between the first image and the second image is obtained (step S5).

Examples of the difference include the difference images Img21 to Img23 in the abovementioned focus mode of the inspection apparatus. Additionally, in the abovementioned polarization mode of the inspection apparatus, examples of the difference include differences GDpC61−GDoC51, GDpC62−GDoC52, GDpC63−GDoC53, and GDpC64−GDoC54 between the gradation differences of the portions corresponding to the defects in the optical microscope images from the background in the orthogonal polarization and the gradation differences of the portions corresponding to the defects in the optical microscope images from the background in the parallel polarization.

Finally, the defects are classified by the collation of the obtained differences with the teacher data (step S6).

In the abovementioned polarization mode of the inspection apparatus, the abovementioned differences GDpC61−GDoC51, GDpC62−GDoC52, GDpC63−GDoC53 and GDpC64−GDoC54 are applied to the classifications of the teacher data, and hence, the defects can easily be classified.

Additionally, in the abovementioned focus mode of the inspection apparatus, the characteristic amounts of the difference images Img21 to Img23 are first calculated, and then, the obtained characteristic amounts are collated with the teacher data, and hence, the defects in the difference images can be classified.

The inspection mode of at least one of the abovementioned embodiments includes the classifying of the defects of the sample by use of the first signal obtained by irradiating the sample with the light under the first optical condition and the second signal obtained by irradiating the sample with the light under the second optical condition different from the first optical condition, and hence, the defects can accurately be classified.

(C) Program

A series of steps in the inspection in which the inspection apparatus according to the abovementioned embodiment is used may be incorporated as a recipe file in a program, and read and executed by a general purpose computer. In consequence, the inspection according to the abovementioned embodiment can be realized by using the general purpose computer.

In addition, the abovementioned series of steps of the inspection may be incorporated as a processing procedure in a program to be executed by the computer, stored in a recording medium such as a flexible disc or a CD-ROM, and read and executed by the computer. The recording medium is not limited to a portable medium such as a magnetic disc or an optical disc, and may be a stationary recording medium such as a hard disk or a memory.

(D) Others

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions.

For example, in the above embodiment, an image which is being inspected has been used as an image for use in defect classification, but the present invention is not limited to this example, and there may be used, for example, an image separately imaged by a high-resolution camera after the inspection.

The accompanying claims and their equivalents are intended to cover such forms or modifications as would fall within the scope and spirit of the inventions.

1. An inspection apparatus comprising:
an irradiating section configured to irradiate a sample with light;
a detecting section configured to detect the light reflected by the sample; and
a control section configured to classify defects of the sample on the basis of a difference between a first signal outputted from the detecting section by irradiating the sample with the light under a first optical condition and a second signal outputted from the detecting section by irradiating the sample with the light under a second optical condition different from the first optical condition.

2. The apparatus of claim 1,
wherein the control section calculates a characteristic amount of the difference to classify the defects.

3. The apparatus of claim 1,
wherein the first optical condition is different from the second optical condition in focal position of the light with which the sample is to be irradiated.

4. The apparatus of claim 3,
wherein the focal position of the first optical condition is present on the surface of the sample, and the focal position of the second optical condition is present in the sample.

5. The apparatus of claim 1,
wherein the first optical condition is different from the second optical condition in polarizing direction of the light with which the sample is to be irradiated, and
the polarizing direction of the first optical condition intersects the polarizing direction of the second optical condition.

6. An inspection method comprising:
irradiating a sample with light under a first optical condition and detecting the light reflected by the sample to acquire a first signal;
irradiating the sample with the light under a second optical condition different from the first optical condition and detecting the light reflected by the sample to acquire a second signal; and
classifying defects of the sample on the basis of a difference between the first signal and the second signal.

7. The method of claim 6, further comprising:
calculating a characteristic amount of the difference,
wherein the defects are classified on the basis of the characteristic amount.

8. The method of claim 6,
wherein the first optical condition is different from the second optical condition in focal position of the light with which the sample is to be irradiated.

9. The apparatus of claim 8,
wherein the focal position of the first optical condition is present on the surface of the sample, and the focal position of the second optical condition is present in the sample.

10. The apparatus of claim 6,
wherein the first optical condition is different from the second optical condition in polarizing direction of the light with which the sample is to be irradiated, and
the polarizing direction of the first optical condition intersects the polarizing direction of the second optical condition.
